(19) United States
(12) Patent Application Publication
(10) Pub. No.: US 2020/0124740 A1
(43) Pub. Date: Apr. 23, 2020

(54) METHOD AND SYSTEM FOR TIMING SYNCHRONIZATION OF UNMANNED AERIAL VEHICLE AND UNMANNED AERIAL VEHICLE

(71) Applicant: SZ DJI TECHNOLOGY CO., LTD., Shenzhen (CN)

(72) Inventor: Xiaodong WANG, Shenzhen (CN)

(21) Appl. No.: 16/719,110

(22) Filed: Dec. 18, 2019

Related U.S. Application Data
(63) Continuation of application No. PCT/CN2017/090250, filed on Jun. 27, 2017.

(51) Int. Cl. G01S 19/25; G01S 19/33; B64C 39/02

(52) U.S. Cl. CPC G01S 19/256; G01S 19/33; B64C 2201/145; B64C 2201/12; B64C 39/024

(57) ABSTRACT

A method for unmanned aerial vehicle (UAV) timing synchronization includes a communication system of a UAV receiving a synchronization signal transmitted by a positioning device of the UAV, and adjusting timing of the communication system at a preset time point after receiving the synchronization signal.

### CROSS-REFERENCE TO RELATED APPLICATION

This application is a continuation of International Application No. PCT/CN2017/090250, filed on Jun. 27, 2017, the entire content of which is incorporated herein by reference.

### TECHNICAL FIELD

The present disclosure relates to unmanned aerial vehicle technologies and, more particularly, to a method and a system for timing synchronization for unmanned aerial vehicles, and an unmanned aerial vehicle.

### BACKGROUND

When a plurality of unmanned aerial vehicles of the existing technology communicate with each other, timing synchronization for wireless communication is required between the plurality of unmanned aerial vehicles.

Currently, a method for timing synchronization for wireless communication between the plurality of unmanned aerial vehicles may include a point-to-point (P2P) synchronization system or a point-to-multipoint (P2MP) master-slave synchronization system, formed among the plurality of unmanned aerial vehicles. In the point-to-multipoint master-slave synchronization system, each unmanned aerial vehicle may be considered as a node. A synchronization signal may be transmitted from a master node to slave nodes. Based on the synchronization signal, the slave nodes may adjust synchronization timing correspondingly. That is, the slave nodes may be synchronized with the master node.

However, once the master node becomes invalid or faulty, the slave nodes may no longer receive the synchronization signal and may not be able to adjust the synchronization timing correspondingly, thereby disrupting normal operation of the synchronization system.

### SUMMARY

In accordance with the disclosure, there is provided a method for unmanned aerial vehicle (UAV) timing synchronization including a communication system of a UAV receiving a synchronization signal transmitted by a positioning device of the UAV, and adjusting timing of the communication system at a preset time point after receiving the synchronization signal.

Also in accordance with the disclosure, there is provided an unmanned aerial vehicle (UAV) including a vehicle body, a power system mounted at the vehicle body and configured to provide flight power, a flight controller communicatively coupled with the power system to control flight of the unmanned aerial vehicle, and a timing synchronization system. The timing synchronization system includes a positioning device configured to transmit a synchronization signal and a communication system configured to receive the synchronization signal from the positioning device and adjust timing of the communication system at a preset time point after receiving the synchronization signal.

### BRIEF DESCRIPTION OF THE DRAWINGS

To more clearly illustrate the technical solution of the present disclosure, the accompanying drawings used in the description of the disclosed embodiments are briefly described hereinafter. Obviously, the drawings described below are merely some embodiments of the present disclosure. Other drawings may be derived from such drawings by a person with ordinary skill in the art without creative efforts and may be encompassed in the present disclosure.

FIG. 1 is a flow chart of a method for unmanned aerial vehicle (UAV) timing synchronization according to an example embodiment.

FIG. 2 is a flow chart of a method for UAV timing synchronization according to another example embodiment.

FIG. 3 is a timing diagram of a method for UAV timing synchronization according to an example embodiment.

FIG. 4 is a schematic diagram of a system for UAV timing synchronization according to an example embodiment.

FIG. 5 is a schematic diagram of an unmanned aerial vehicle according to an example embodiment.

### REFERENCE NUMERALS

40 system for UAV timing synchronization

41 communication system

42 positioning device

100 UAV

102 supporting device

104 imaging device

106 propeller

107 electric motor

108 sensor system

110 communication system

111 positioning device

112 ground station

114 antenna

116 electromagnetic wave

117 electronic speed controller, and

118 flight controller.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

It should be noted that, in some embodiments, when one component is “fixedly connected” or “connected” to another component, or one component is “fixed” to another component, the component may directly contact the another component, or may not directly contact the another component and may have something in-between.

Unless otherwise specified, all the technical and scientific terms used in the embodiments of the present disclosure refer to the same meaning commonly understood by those skilled in the art. The terminologies used in the present disclosure are intended to describe specific embodiments, and not to limit the scope of the present disclosure. The term “and/or” includes any and all combinations of one or more of the listed items.

Embodiments of the present disclosure are described in detail below with reference to the accompanying drawings. Features of the embodiments and examples described below may be combined with each other under the circumstances of non-conflicting.

Generally, an unmanned aerial vehicle (UAV) includes a communication system. The communication system may communicate with a ground station or a communication system of a peer unmanned aerial vehicle. In particular, the communication system may be a wireless communication system. The wireless communication systems of a plurality of unmanned aerial vehicles may be synchronized or unsynchronized.

When the plurality of unmanned aerial vehicles having unsynchronized wireless communication systems form a communication network, the wireless communication system (e.g., at a physical layer thereof) of each unmanned aerial vehicle may compete for signal channels in a random access method. In this case, signals in the signal channels are likely to collide with each other and to cause transmission failures or reception failures, thereby degrading data transmission efficiency of the communication network. To avoid signal collisions in the signal channels and improve the data transmission efficiency of the communication network, a timing synchronization of the wireless communications between the plurality of unmanned aerial vehicles is required. The method for UAV timing synchronization will be described below with various embodiments.

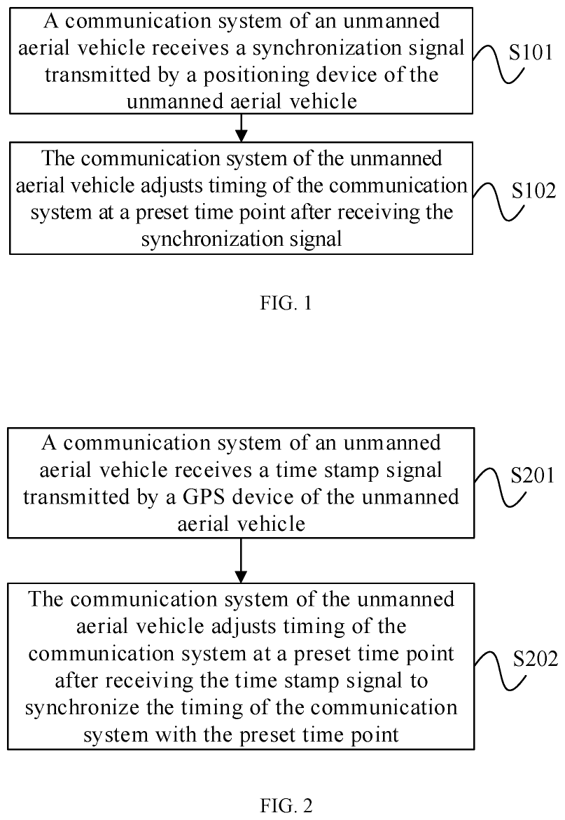

The present disclosure provides a method for UAV timing synchronization. FIG. 1 is a flow chart of a method for UAV timing synchronization according to an example embodiment. As shown in FIG. 1, the method may include the following steps.

At S101, a communication system of an unmanned aerial vehicle receives a synchronization signal transmitted by a positioning device of the unmanned aerial vehicle.

The positioning device of the unmanned aerial vehicle is often used in positioning and navigation. In some embodiments, the synchronization signal transmitted by the positioning device of the unmanned aerial vehicle may be used to adjust timing of the communication system of the unmanned aerial vehicle. Specifically, the synchronization signal transmitted by the positioning device of each unmanned aerial vehicle may be synchronized. The timing of the communication system of each unmanned aerial vehicle may be adjusted by the synchronization signal transmitted by the positioning device of the unmanned aerial vehicle. Thus, the timing synchronization of the communication systems of the plurality of unmanned aerial vehicles may be achieved.

In some embodiments, the communication system of the unmanned aerial vehicle may receive the synchronization signal transmitted by the positioning device of the unmanned aerial vehicle. For example, the communication system of the unmanned aerial vehicle A may receive the synchronization signal transmitted by the positioning device of the unmanned aerial vehicle A, and the communication system of the unmanned aerial vehicle B may receive the synchronization signal transmitted by the positioning device of the unmanned aerial vehicle B.

In some embodiments, the positioning device may be a global positioning system (GPS) device. The synchronization signal may include a PPS (pulse per second) signal. The PPS signal is synchronized with a satellite, for example, a GPS satellite.

In some embodiments, the communication system of the unmanned aerial vehicle receiving the synchronization signal transmitted by the positioning system of the unmanned aerial vehicle may include the communication system of the unmanned aerial vehicle receiving the PPS signal transmitted by the GPS system of the unmanned aerial vehicle. For example, the communication system of the unmanned aerial vehicle A may receive the PPS signal transmitted by the GPS system of the unmanned aerial vehicle A, and the communication system of the unmanned aerial vehicle B may receive the PPS signal transmitted by the GPS system of the unmanned aerial vehicle B. Because the PPS signal is synchronized with the GPS satellite, the PPS signal transmitted by the GPS system of the unmanned aerial vehicle A is synchronized with the PPS signal transmitted by the GPS system of the unmanned aerial vehicle B. That is, the GPS system of the unmanned aerial vehicle A and the GPS system of the unmanned aerial vehicle B transmit the respective PPS signal at the same time point.

At S102, the communication system of the unmanned aerial vehicle adjusts timing of the communication system at a preset time point after receiving the synchronization signal.

In some embodiments, the communication system of the unmanned aerial vehicle may adjust the timing of the communication system at the preset time point after the communication system of the unmanned aerial vehicle receives the PPS signal to synchronize the timing of the communication system with the preset time point.

Because the synchronization signals (e.g., PPS signals) transmitted by the positioning devices (e.g., GPS system) of the unmanned aerial vehicles are synchronized, the communication systems of different unmanned aerial vehicles may receive the synchronization signals at the same time point. For example, the GPS systems of the unmanned aerial vehicle A and the unmanned aerial vehicle B transmit the PPS signal at the same time point. The communication system of the unmanned aerial vehicle A and the communication system of the unmanned aerial vehicle B may receive the PPS signals at the same time point.

The communication system of each unmanned aerial vehicle may adjust the timing of the communication system ay the preset time point after the communication system of the unmanned aerial vehicle receives the synchronization signal (e.g., the PPS signal). Because the communication systems of different unmanned aerial vehicles receive the synchronization signal (e.g., the PPS signal) at the same time point, the preset time point after the receiving time point with respect to different unmanned aerial vehicles may still be the same time point.

For example, the communication system of the unmanned aerial vehicle A and the communication system of the unmanned aerial vehicle B may receive the PPS signal at time point Tr. In some embodiments, the preset time point may be a time point that is an interval t after the time point Tr, and may be time point (Tr+t). The communication system of the unmanned aerial vehicle A may adjust the timing at the preset time point after the time point Tr, that is, the time point (Tr+t). After the adjustment, the timing of the communication system of the unmanned aerial vehicle A may be synchronized with the preset time point, that is, the time point (Tr+t). Similarly, the communication system of the unmanned aerial vehicle B may adjust the timing at the preset time point after the time point Tr, that is, the time point (Tr+t). After the adjustment, the timing of the communication system of the unmanned aerial vehicle B may be synchronized with the preset time point, that is, the time point (Tr+t).

Obviously, both the timing of the communication system of the unmanned aerial vehicle A and the timing of the communication system of the unmanned aerial vehicle B may be synchronized with the preset time point, that is, the time point (Tr+t) to achieve the synchronization between the timing of the communication system of the unmanned aerial vehicle A and the timing of the communication system of the unmanned aerial vehicle B. For illustrative purposes, only two unmanned aerial vehicles are described. The method for timing synchronization may be extended to multiple (more than two) unmanned aerial vehicles without loss of generality. The timing of the communication system of each unmanned aerial vehicle may be synchronized with the preset time point to achieve the timing synchronization of the communication systems of multiple unmanned aerial vehicles.

In some embodiments, the communication system may include a wireless communication circuit. When timing of the communication systems of multiple unmanned aerial vehicles is synchronized, the multiple unmanned aerial vehicles may communicate with each other through the wireless communication circuits of the communication systems.

In some embodiments, the communication system of the unmanned aerial vehicle may receive the synchronization signal transmitted by the positioning device of the unmanned aerial vehicle and may adjust the timing of the communication system at the preset time point after receiving the synchronization signal. The synchronization signal transmitted by the positioning device of each unmanned aerial vehicle may be synchronized. Based on the synchronization signal transmitted by the positioning device of the unmanned aerial vehicle, the communication system of each unmanned aerial vehicle may adjust the timing, thereby achieving the timing synchronization of the communication systems of multiple unmanned aerial vehicles.

When multiple unmanned aerial vehicles form a network and the communication system of one of the unmanned aerial vehicles fails, the communication systems of the remaining unmanned aerial vehicles may still be able to adjust the timing based on the synchronization signals transmitted by the positioning devices of the remaining unmanned aerial vehicles. The method for timing synchronization may be independent of the synchronization signal transmitted by the unmanned aerial vehicle at the master node, and may avoid loss of the timing synchronization when the master node becomes invalid or faulty and the slave nodes are not able to adjust the synchronization timing in absence of the synchronization signals. Thus, the normal synchronization and normal communication may be ensured when multiple unmanned aerial vehicles form the network.

The present disclosure provides another method for UAV timing synchronization. FIG. 2 is a flow chart of a method for UAV timing synchronization according to another example embodiment. As shown in FIG. 2, at S201, a communication system of an unmanned aerial vehicle receives a time stamp signal transmitted by a GPS device of the unmanned aerial vehicle.

In some embodiments, the operation principle and the implementation detail of S102 may be similar to the embodiment illustrated in FIG. 1 and will not be repeated herein.

At S202, the communication system of the unmanned aerial vehicle adjusts timing of the communication system at a preset time point after receiving the time stamp signal to synchronize the timing of the communication system with the preset time point.

In some embodiments, adjusting the timing of the communication system by the communication system of the unmanned aerial vehicle at the preset time point after receiving the time stamp signal may include adjusting a duration of a physical layer frame corresponding to a target time point by the communication system of the unmanned aerial vehicle at the preset time point. The target time point may be a time point when the communication system receives the time stamp signal.

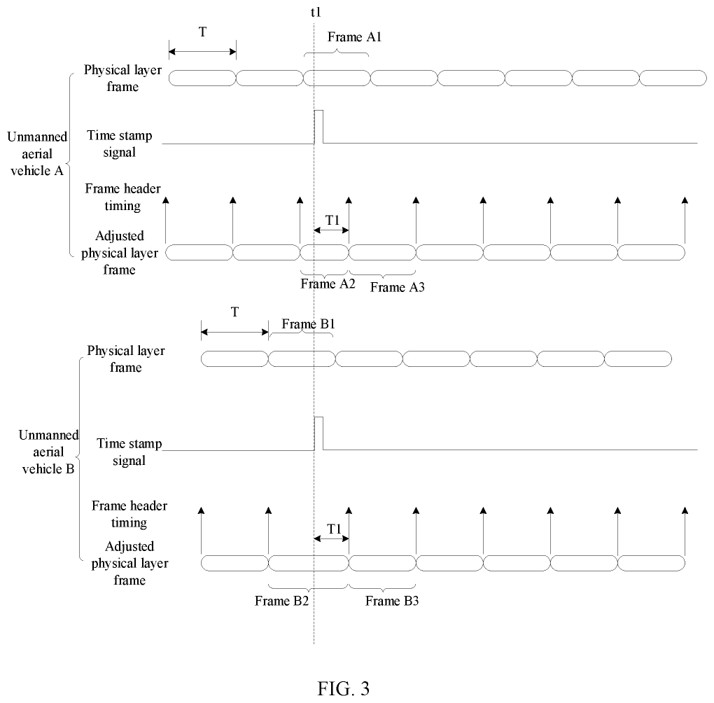

FIG. 3 is a timing diagram of a method for UAV timing synchronization according to an example embodiment. As shown in FIG. 3, the communication system of the unmanned aerial vehicle A and the communication system of the unmanned aerial vehicle B receive the time stamp signal at the time point t1. In some embodiments, the time point when the communication system receives the time stamp signal is recorded as the target time point, such as the time point t1. In some embodiments, the time stamp signal may be a pulse signal. The time point when the communication system receives the time stamp signal is at a rising edge of the time stamp signal. As shown in FIG. 3, the time point t1 is at the rising edge of the pulse signal.

The method of recording the target time point by the communication system of the unmanned aerial vehicle A or the communication system of the unmanned aerial vehicle B is described below. For illustrative purposes, the communication system of the unmanned aerial vehicle A is described in the embodiment of the method. When the communication system of the unmanned aerial vehicle A receives the PPS signal, the PPS pulse may trigger a physical layer timer of the communication system. For example, the physical layer timer may be a counter that counts based on a fixed clock. When the PPS pulse is detected, the physical layer of the unmanned aerial vehicle A may record a count number of the physical layer timer. The count number may indicate the time point when the PPS pulse is detected. At the same time point, the count number may also indicate the time point when the communication system receives the PPS pulse, that is, the rising edge of the PPS pulse received by the communication system.

The operation principle and the implementation detail of recording the target time point by the communication system of the unmanned aerial vehicle B may be the same as the operation principle and the implementation detail of recording the target time point by the communication system of the unmanned aerial vehicle A and will not be repeated herein.

As shown in FIG. 3, the communication system of the unmanned aerial vehicle A receives the PPS signal at the time point t1. The time point t1 corresponds to Frame A1 as the physical layer frame of the unmanned aerial vehicle A. The communication system of the unmanned aerial vehicle B also receives the PPS signal at the time point t1. The time point t1 corresponds to Frame B1 as the physical layer frame of the unmanned aerial vehicle B. As shown in FIG. 3, the physical layer frame of the unmanned aerial vehicle A and the physical layer frame of the unmanned aerial vehicle B have a same length T in time. However, the physical layer frame of the unmanned aerial vehicle A and the physical layer frame of the unmanned aerial vehicle B are not synchronized. In some embodiments, the timing synchronization of the communication system of the unmanned aerial vehicle A and the communication system of the unmanned aerial vehicle B may be achieved by synchronizing the physical layer frame of the unmanned aerial vehicle A with the physical layer frame of the unmanned aerial vehicle B.

In some embodiments, the communication system of the unmanned aerial vehicle A may adjust a duration of Frame A1 at the preset time point after the time point t1. The communication system of the unmanned aerial vehicle B may adjust a duration of Frame B1 at the preset time point after the time point t1. As shown in FIG. 3, the preset time point may be the time point (t1+T1). That is, the preset time point may be a time point that is a time interval T1 later than the time point t1. The communication system of the unmanned aerial vehicle A may adjust the duration of Frame A1 at the time point (t1+T1). The communication system of the unmanned aerial vehicle B may adjust the duration of Frame B1 at the time point (t1+T1). As shown in FIG. 3, after the adjustment, the physical layer frame Frame A1 becomes a physical layer frame Frame A2, and the physical layer frame Frame B1 becomes a physical layer frame Frame B2.

Adjusting the duration of the physical layer frame corresponding to the target time point by the communication system of the unmanned aerial vehicle at the preset time point may include breaking up the physical layer frame corresponding to the target time point by the communication system of the unmanned aerial vehicle at the preset time point. For example, the communication system of the unmanned aerial vehicle A may break up the Frame A1 at the time point (t1+T1). The original Frame A1 may turn into the Frame A2. Compared to the Frame A1, the Frame A2 may have a shorter duration. The communication system of the unmanned aerial vehicle B may break up the frame B1 at the time point (t1+T1). The original frame B1 may turn into the frame B2. Compared to the Frame B1, the Frame B2 may have a longer duration. However, both the Frame A2 and the Frame B2 may end at the same time point (t1+T1).

The physical layer frames after the preset time point may have the same duration as the physical layer frames before the preset time point. As shown in FIG. 3, after the time point (t1+T1), the adjusted physical layer frames of the unmanned aerial vehicle A may have the same duration T as the physical layer frames of the unmanned aerial vehicle A before the time point t1. After the time point (t1+T1), the adjusted physical layer frames of the unmanned aerial vehicle B may have the same duration T as the physical layer frames of the unmanned aerial vehicle B before the time point t1.

In addition, the preset time point may be a start time point of a next physical layer frame after the physical layer frame corresponding to the target time point. As shown in FIG. 3, the time point (t1+T1) may be an end time point of the physical layer Frame A2 of the unmanned aerial vehicle A and at the same time point, may be a start time point of a physical layer Frame A3 of the unmanned aerial vehicle A. The physical layer Frame A3 is a physical layer frame subsequent to the physical layer Frame A2. Similarly, the time point (t1+T1) may be an end time point of the physical layer Frame B2 of the unmanned aerial vehicle B and at the same time point, may be a start time point of a physical layer Frame B3 of the unmanned aerial vehicle B. The physical layer Frame B3 is a physical layer frame subsequent to the physical layer Frame B2.

Both the Frame A2 and the Frame B2 may end at the same time point (t1+T1), and both the Frame A3 and the Frame B3 may start at the same time point (t1+T1). The physical layer frames subsequent to the Frame A3 may have a duration T. The physical layer frames subsequent to the Frame B3 may have a duration T. Starting from the time point (t1+T1), the communication system of the unmanned aerial vehicle A and the communication system of the unmanned aerial vehicle B may be synchronized.

The following further describes how the communication system of the unmanned aerial vehicle A breaks up the Frame A1 at the time point (t1+T1) and how the communication system of the unmanned aerial vehicle B breaks up the Frame B1 at the time point (t1+T1). For illustrative purposes, the communication system of the unmanned aerial vehicle A is described. When the communication system of the unmanned aerial vehicle A receives the PPS signal at the time point t1, the PPS pulse may trigger a physical layer timer to start counting. At this moment, the physical layer timer of the unmanned aerial vehicle A may have a count number t1. Further, the physical layer of the unmanned aerial vehicle A may calculate a break-up time point for the physical layer Frame A1 corresponding to the time point t1.

In some embodiments, the break-up time point of the Frame A1 may be a preset time point after the time point t1. That is, the physical layer of the unmanned aerial vehicle A may add the preset time point interval T1 to the time point t1 to obtain the break-up time point of the Frame A1 as the time point (t1+T1). When the physical layer timer of the unmanned aerial vehicle A reaches the time point (t1+T1), the timer may generate a break-up signal. At the same time point the timer generates the break-up signal, the communication system of the unmanned aerial vehicle A may break up the Frame Al. The operation principle and the implementation detail of how the communication system of the unmanned aerial vehicle B breaks up the Frame B1 at the time point (t1+T1) may be the same as the operation principle and the implementation detail of how the communication system of the unmanned aerial vehicle A breaks up the Frame A1 at the time point (t1+T1) and will not be repeated herein.

Without loss of generality, when multiple unmanned aerial vehicles form a network, an agreement may be reached in advance. In the agreement, a communication system of each of the multiple unmanned aerial vehicles may break up a physical layer frame of the unmanned aerial vehicle corresponding to a preset time point after the time point at which a PPS signal is received.

In some embodiments, a duration from the target time point to the preset time point may be one half of a duration of a physical layer frame before the target time point. As shown in FIG. 3, T1 may be one half of T. The T1 value is intended to be illustrative and does not limit T1 to be other values. In some embodiments, T1 may be other preset value.

In the embodiments of the present disclosure, the communication system of the unmanned aerial vehicle may adjust the duration of the physical layer frame corresponding to the target time point at the preset time point after receiving the time stamp signal. The target time point may be the time point when the communication system receives the time stamp signal. For example, the communication system may break up the physical layer frame corresponding to the target time point at the preset time point. When multiple unmanned aerial vehicles form a network, the unmanned aerial vehicles may receive the time stamp signal at the same time point. If each and every unmanned aerial vehicle breaks up the physical layer frame corresponding to the target time point at the preset time point, the physical layer frame of each and every unmanned aerial vehicle may end at the preset time point. Starting from the preset time point, the timing of the communication systems of the unmanned aerial vehicles may be synchronized. Subsequently, the communication systems of the unmanned aerial vehicles may transmit signals in the signal channels based on time sequence instead of competing for signal channels in the random access method. Thus, signal collisions in the signal channels may be avoided and the data transmission efficiency of the network may be improved.

In some embodiments, a duration from the target time point to the preset time point may be greater than a pulse width of the time stamp signal. As shown in FIG. 3, the duration T1 from the target time point t1 to the preset time point (t1+T1) is greater the pulse width of the time stamp signal.

In addition, the rising edge of the time stamp signal may be at a time point other than the start time point or the end time point of the physical layer frame. Because the time stamp signal is a periodical signal, a period of the time stamp signal may be an integer multiple of the duration of the physical layer frame before the target time point. For example, the period of the time stamp signal is one second. That is, the time stamp signal appears every one second. As shown in FIG. 3, other than the physical layer frame corresponding to the target time point t1, the physical layer frames after the adjustment may have the duration T as one millisecond. That is, the period of the time stamp signal is an integer multiple of T.

It is assumed that the rising edge of the first time stamp signal aligns with the start time point of the physical layer frame of a certain unmanned aerial vehicle. If a clock of the unmanned aerial vehicle does not drift, when the second time stamp signal appears, the rising edge of the second time stamp signal may still align with the start time point of the physical layer frame of the unmanned aerial vehicle. If the clock of the unmanned aerial vehicle drifts, the rising edge of the second time stamp signal may not align with the start time point of the physical layer frame of the unmanned aerial vehicle. The rising edge of the second time stamp signal may be earlier than the start time point of the physical layer frame of the unmanned aerial vehicle or may be later than the start time point of the physical layer frame of the unmanned aerial vehicle. That is, it is uncertain when the rising edge of the second time stamp signal may appear. Similarly, if the rising edge of the first time stamp signal aligns with the end time point of the physical layer frame, it is still uncertain when the rising edge of the second time stamp signal may appear. Thus, to avoid the uncertainty, the rising edge of the time stamp signal may appear at any time other than the start time point or the end time point of the physical layer frame, and the pulse width of the time stamp signal may be within the duration of the same physical layer frame.

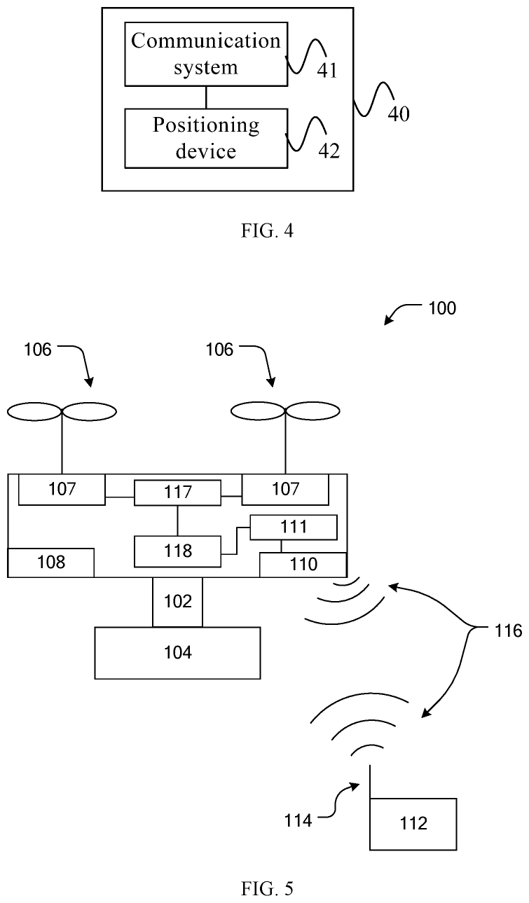

The present disclosure provides a system for UAV timing synchronization. FIG. 4 is a schematic diagram of a system for UAV timing synchronization according to an example embodiment. As shown in FIG. 4, the system 40 for UAV timing synchronization includes a communication system 41 and a positioning device 42. The communication system 41 may receive a synchronization signal transmitted by the positioning device 42 of the unmanned aerial vehicle. The communication system 41 of the unmanned aerial vehicle may adjust the timing of the communication system 41 at a preset time point after receiving the synchronization signal.

In some embodiments, the positioning device 41 may be a global positioning system (GPS) device. The synchronization signal may include a time stamp signal. The time stamp signal is synchronized with a satellite, for example, a GPS satellite.

In some embodiments, the receiving of the synchronization signal transmitted by the positioning device 42 of the unmanned aerial vehicle by the communication system 41 of the unmanned aerial vehicle may include receiving of the time stamp signal transmitted by the GPS device of the unmanned aerial vehicle by the communication system 41 of the unmanned aerial vehicle.

In some embodiments, adjusting the timing of the communication system 41 by the communication system 41 of the unmanned aerial vehicle at the preset time point after receiving the time stamp signal may include adjusting the timing of the communication system 41 at the preset time point after receiving the time stamp signal, such that the timing of the communication system 41 may be synchronized with the preset time point.

The operation principle and the implementation detail of the system for UAV timing synchronization based on the present disclosure may be similar to the embodiment illustrated in FIG. 1 and will not be repeated herein.

In some embodiments, the communication system of the unmanned aerial vehicle may receive the synchronization signal transmitted by the positioning device of the unmanned aerial vehicle and may adjust the timing of the communication system at the preset time point after receiving the synchronization signal. The synchronization signals transmitted by the positioning devices of multiple unmanned aerial vehicles may be synchronized. The communication system of each unmanned aerial vehicle may adjust the timing based on the synchronization signal transmitted by the positioning device of the unmanned aerial vehicle to achieve the timing synchronization of the communications systems of the unmanned aerial vehicles.

When multiple unmanned aerial vehicles form a network, if the communication system of any one of the unmanned aerial vehicles fails, the communication systems of the remaining unmanned aerial vehicles may still adjust the timing based on the synchronization signals transmitted by the positioning devices of the unmanned aerial vehicles. The system for timing synchronization may be independent of the synchronization signal transmitted by the unmanned aerial vehicle at the master node and may avoid loss of the timing synchronization when the master node becomes invalid or faulty and the slave nodes are not able to adjust the synchronization timing in absence of the synchronization signals. Thus, the normal synchronization and normal communication may be ensured when multiple unmanned aerial vehicles form the network.

The present disclosure provides the system for UAV timing synchronization. In some embodiments, adjusting the timing of the communication system 41 by the communication system 41 of the unmanned aerial vehicle at the preset time point after receiving the time stamp signal may include adjusting the duration of a physical layer frame corresponding to a target time point by the communication system 41 of the unmanned aerial vehicle at the preset time point, where the target time point is the time point when the communication system 41 receives the time stamp signal.

In some embodiments, the time stamp signal may be a pulse signal. A time when the communication system 41 receives the time stamp signal corresponds to a rising edge of the time stamp signal.

Adjusting the duration of the physical layer frame corresponding to the target time point by the communication system of the unmanned aerial vehicle at the preset time point may include breaking up the physical layer frame corresponding to the target time point by the communication system 41 of the unmanned aerial vehicle at the preset time point.

In some embodiments, a duration from the target time point to the preset time point may be equal to a pulse width of the time stamp signal. The duration from the target time point to the preset time point may be one half of the duration of the physical layer frames before the target time point. The preset time point may be a start time point of the physical layer frame subsequent to the physical layer frame corresponding to the target time point. The duration of the physical layer frames after the preset time point may be equal to the duration of the physical layer frames before the target time point.

In addition, the time stamp signal is a periodical signal. The period of the time stamp signal may be an integer multiple of the duration of the physical layer frames before the target time point.

Further, the communication system 41 may include a wireless communication circuit.

The operation principle and the implementation detail of the system for UAV timing synchronization according to the present disclosure may be similar to the embodiments illustrated in FIG. 2 and FIG. 3 and will not be repeated herein.

In the embodiments of the present disclosure, the communication system of the unmanned aerial vehicle may adjust the duration of the physical layer frame corresponding to the target time point at the preset time point after receiving the time stamp signal. The target time point may be the time when the communication system receives the time stamp signal. For example, the communication system may break up the physical layer frame corresponding to the target time point at the preset time point. When multiple unmanned aerial vehicles form a network, the unmanned aerial vehicles may receive the time stamp signal at the same time point. If each and every unmanned aerial vehicle breaks up the physical layer frame corresponding to the target time point at the preset time point, the physical layer frame of each and every unmanned aerial vehicle may end at the preset time point. Starting from the preset time point, the timing of the communication systems of the unmanned aerial vehicles may be synchronized. Subsequently, the communication systems of the unmanned aerial vehicles may transmit signals in the signal channels based on time sequence instead of competing for signal channels in the random access method. Thus, signal collisions in the signal channels may be avoided and the data transmission efficiency of the network may be improved.

The present disclosure also provides an unmanned aerial vehicle. FIG. 5 is a schematic diagram of an unmanned aerial vehicle according to an example embodiment. As shown in FIG. 5, the unmanned aerial vehicle 100 includes a vehicle body, a power system, a flight controller 118, and a timing synchronization system. The power system includes at least one of an electric motor 107, propellers 106, or an electronic speed controller 117. The power system may be mounted at the vehicle body for providing flight power. The flight controller 118 may communicate and couple with the power system to control the flight of the unmanned aerial vehicle. The flight controller 118 may include an inertial measurement unit (IMU). The inertial measurement unit may often include a gyroscope and an accelerometer. The inertial measurement unit may be used to detect a pitch angle, a roll angle, a yaw angle, and an acceleration, etc., of the unmanned aerial vehicle, such as an agricultural unmanned aerial vehicle.

In some embodiments, as shown in FIG. 5, the timing synchronization system includes a positioning device 111 and a communication system 110. The operation principle and the implementation detail of the timing synchronization system may be similar to the embodiments illustrated previously and will not be repeated herein.

In addition, as shown in FIG. 5, the unmanned aerial vehicle 100 may also include a sensor system 108, a supporting device 102, and an imaging device 104. The supporting device 102 may be a gimbal. The communication system 110 may include a receiver. The receiver may be used to receive wireless signals transmitted by an antenna 114 of a ground station 112. The receiver and the antenna 114 may communicate through electromagnetic waves 116. Further, the communication system 110 may also include a wireless communication circuit. The wireless communication circuit may be used to wirelessly communicate with other unmanned aerial vehicles.

In some embodiments, the communication system of the unmanned aerial vehicle may receive the synchronization signal transmitted by the positioning device of the unmanned aerial vehicle and may adjust the timing of the communication system at the preset time point after receiving the synchronization signal. The synchronization signals transmitted by the positioning devices of multiple unmanned aerial vehicles may be synchronized. The communication system of each unmanned aerial vehicle may adjust the timing based on the synchronization signal transmitted by the positioning device of the unmanned aerial vehicle to achieve the timing synchronization of the communications systems of the unmanned aerial vehicles.

When multiple unmanned aerial vehicles form a network, if the communication system of any one of the unmanned aerial vehicles fails, the communication systems of the remaining unmanned aerial vehicles may still adjust the timing based on the synchronization signals transmitted by the positioning devices of the unmanned aerial vehicles. The system for timing synchronization may be independent of the synchronization signal transmitted by the unmanned aerial vehicle at the master node and may avoid loss of the timing synchronization when the master node becomes invalid or faulty and the slave nodes are not able to adjust the synchronization timing in absence of the synchronization signals. Thus, the normal synchronization and normal communication may be ensured when multiple unmanned aerial vehicles form the network.

In the embodiments of the present disclosure, the disclosed method and system may be implemented differently. For example, the embodiments describing the disclosed system may be for illustrative purposes. The division of circuits may only be a logic and function division. Actual implementation may include different divisions. For example, a plurality of circuits or assemblies may be combined or integrated into a different system. Certain features may be omitted or not executed. In addition, a mutual coupling, a direct coupling, or a communication connection as illustrated or discussed may be implemented through interfaces. The direct coupling or communication connection between devices or circuits may be electrical, mechanical, or in other forms.

Units described as separate components may or may not be physically separated. Components illustrated as circuits may or may not be physical units. That is, the components may be disposed at one location or may be distributed as a plurality of networked units. Based on the actual needs, some or all of the units may be selected to achieve the objectives of the embodiments of the present disclosure.

In addition, each functional unit in various embodiments may be integrated into one processing unit or may function as physically separated units. Two or more units may be integrated into one unit. The integrated units may be implemented as hardware, software, or a combination of hardware and software.

The integrated units implemented as software may be stored in a computer-readable medium. The software function units may be stored in a storage medium, including a plurality of program instructions for a computer (e.g., a personal computer, a server, or a network device, etc.) or a processor to execute certain steps of the method embodiments. The storage medium may include a USB drive, a portable disk, a read-only memory (ROM), a random access memory (RAM), a magnetic disk, an optical disk, or other media that can store program instructions.

It should be understood by those skilled in the art that, for convenience and brevity of the description, a division of function modules/circuits is only intended to be illustrative. In practical applications, function assignments may be completed by different function modules/circuits as needed. That is, internal structures of a device may be divided into different function modules/units to perform some or all of the described functions. The specific operation process of the device may refer to the corresponding process as illustrated in the embodiments of the present disclosure and will not be repeated herein.

The foregoing descriptions are merely some implementation manners of the present disclosure, but the scope of the present disclosure is not limited thereto. Any change or replacement that can be conceived by a person skilled in the art based on the technical scope disclosed by the present application should be covered by the scope of the present disclosure. A true scope and spirit of the invention is indicated by the following claims.

What is claimed is:

1. A method for unmanned aerial vehicle (UAV) timing synchronization, comprising:
receiving, by a communication system of a UAV, a synchronization signal transmitted by a positioning device of the UAV; and
adjusting, by the communication system, timing of the communication system at a preset time point after receiving the synchronization signal.

2. The method of claim 1, wherein the positioning device includes a global positioning system (GPS) device.

3. The method of claim 1, wherein the synchronization signal includes a time stamp signal.

4. The method of claim 3, wherein receiving the synchronization signal transmitted by the positioning device includes:
receiving the time stamp signal transmitted by a global positioning system (GPS) device of the unmanned aerial vehicle.

5. The method of claim 4, wherein adjusting the timing of the communication system at the preset time point after receiving the synchronization signal includes:
adjusting the timing of the communication system at the preset time point after receiving the time stamp signal to synchronize the timing of the communication system with the preset time point.

6. The method of claim 5, wherein adjusting the timing of the communication system includes:
adjusting, at the preset time point, a duration of a physical layer frame corresponding to a target time point, the target time point being a time point at which the communication system receives the time stamp signal.

7. The method of claim 6, wherein:
the time stamp signal includes a pulse signal; and
the time point at which the communication system receives the time stamp signal is at a rising edge of the time stamp signal.

8. The method of claim 6, wherein adjusting the duration of the physical layer frame includes:
breaking up the physical layer frame at the preset time point.

9. The method of claim 8, wherein a duration between the target time point and the preset time point is greater than a pulse width of the time stamp signal.

10. The method of claim 8, wherein a duration between the target time point and the preset time point is one half of a duration of a physical layer frame before the target time point.

11. The method of claim 8, wherein the preset time point is a start time point of a physical layer frame subsequent to the physical layer frame corresponding to the target time point.

12. The method of claim 8, wherein a duration of a physical layer frame after the preset time point is equal to a duration of a physical layer frame before the target time point.

13. The method of claim 3, wherein the time stamp signal is synchronized with a satellite.

14. The method of claim 3, wherein the time stamp signal includes a periodical signal.

15. The method of claim 14, wherein a period of the time stamp signal is an integer multiple of a duration of a physical layer frame before the target time point.

16. The method of claim 1, wherein the communication system includes a wireless communication circuit.

17. An unmanned aerial vehicle (UAV) comprising:
a vehicle body;
a power system mounted at the vehicle body and configured to provide flight power;
a flight controller communicatively coupled with the power system to control flight of the unmanned aerial vehicle; and
a timing synchronization system including:
a positioning device configured to transmit a synchronization signal; and
a communication system configured to:
receive the synchronization signal from the positioning device; and
adjust timing of the communication system at a preset time point after receiving the synchronization signal.

18. The UAV of claim 17, wherein:
the synchronization signal includes a time stamp signal; and
the communication system is further configured to:
adjust, at the preset time point, a duration of a physical layer frame corresponding to a target time point, the target time point being a time point at which the communication system receives the time stamp signal.

19. The UAV of claim 18, wherein the communication system is further configured to:
break up the physical layer frame at the preset time point.

20. The UAV of claim 17, wherein the communication system includes a wireless communication circuit.
